(19) United States
(12) Patent Application Publication
(10) Pub. No.: US 2023/0279683 A1
(43) Pub. Date: Sep. 7, 2023

(54) SPA COVER

(71) Applicant: Sundance Spas, Inc., Chino, CA (US)

(72) Inventors: Luke Allee, Costa Mesa, CA (US); Mark Knight, Venice, CA (US); Erica A. Langpeter Moir, Santa Ana, CA (US)

(21) Appl. No.: 18/159,513

(22) Filed: Jan. 25, 2023

Related U.S. Application Data
(60) Provisional application No. 63/304,126, filed on Jan. 28, 2022.
(60) Provisional application No. 63/366,415, filed on Jun. 15, 2022.
(60) Provisional application No. 63/476,565, filed on Dec. 21, 2022.

(51) Int. Cl. E04H 4/08

(52) U.S. Cl. CPC E04H 4/08

(57) ABSTRACT

Modular spa covers for insulating spa units are described herein. The modular spa covers can include a plurality of panels and a plurality of support structures. The plurality of support structures can be attached to at least one of the pluralities of panels to attached two or more of the plurality of panels to each other. The plurality of support structures can include at least one E-shaped support structure, at least one T-shaped support structure, and/or at least one H-shaped support structure. When attached to the plurality of panels, at least a portion of each of the plurality of support structures can be embedded within the plurality of panels. The plurality of panels and the plurality of support structures can be packaged inside a spa unit during transportation.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 C.F.R. § 1.57.

This application claims priority to U.S. Provisional Patent Application No. 63/304,126, filed Jan. 28, 2022, U.S. Provisional Patent Application No. 63/366,415, filed Jun. 15, 2022, and U.S. Provisional Patent Application No. 63/476,565, filed Dec. 21, 2022, all of which are hereby incorporated by reference in their entirety.

### TECHNICAL FIELD

The present invention relates generally to a modular spa cover.

### BACKGROUND

Spas or hot tubs often include covers for many reasons. Covers provide a safety feature to prevent children or pets from jumping into the spa. Spa covers can also keep the water clean and free from any contaminants that could fall into the water. Moreover, spa covers can prevent air or heat from escaping, which can reduce the amount of strain put on the circulation system to heat the water. This will save energy and reduce the electricity bill.

### SUMMARY

Spa covers are designed to cover the top side of the spa, making them relatively large in size. Given the large size, it can be difficult to transport spa covers. Moreover, spa users often have difficulty removing the cover from the spa or repositioning the cover on the spa. The spa covers described herein are designed to overcome these challenging without sacrificing other benefits of spa covers, including preventing air or heat from escaping. In several embodiments, the spa covers described herein have one or more of the following advantages:
decrease the amount of space occupied by the spa cover in inventory;
decrease the amount of space occupied by the spa cover during transport;
compatibility with different model spas;
minimize heat escaping the spa; and
protect the spa cover from the external environment to increase longevity.

According to some embodiments, a spa cover configured to cover a spa shell includes a plurality of panels, including a first panel and a second panel, and a plurality of support structures, including a first support structure, a second support structure, and a third support structure. The first support structure can be configured to join a first edge of the first panel and a first edge of the second panel. The second support structure can be configured to join a second edge of the first panel and a second edge of the second panel. The third support structure can be configured to join a third edge of the first panel and a third edge of the second panel, the third edge of the first panel facing the third edge of the second panel when assembled. When assembled, the plurality of panels and the plurality of support structures can form a first subassembly. Each of the panels can be sized such that a length or width of the individual panels is no more than half a length or half a width of the entire spa cover or spa unit. The spa cover can include an outer covering configured to cover the first subassembly.

A variation of the aspect above is, wherein the spa cover further includes a first vapor barrier configured to surround the first subassembly and disposed within the outer covering.

A variation of the aspect above is, wherein the first vapor barrier can be an enclosure including an opening configured to receive the first subassembly.

A variation of the aspect above is, wherein the opening of the first vapor barrier can be configured to be sealed.

A variation of the aspect above is, wherein the sealed opening of the first vapor barrier can be configured to be re-opened or permanently sealed.

A variation of the aspect above is, wherein the first support structure is embedded in the first edge of the first panel and the first edge of the second panel, and at least a portion of the first support structure is exposed from the first panel and the second panel. But in other embodiments, the first support structure may surround at least a partial thickness or a full thickness of the first panel and the second panel.

A variation of the aspect above is, wherein the first support structure is a C-shaped structure, an E-shaped support structure, or a T-shaped support structure.

A variation of the aspect above is, wherein the second support structure is embedded in the second edge of the first panel and the second edge of the second panel, and at least a portion of the second support structure is exposed from the first panel and the second panel. But in other embodiments, the second support structure may surround at least a partial thickness or a full thickness of the first panel and the second panel.

A variation of the aspect above is, wherein the second support structure is a C-shaped support structure, an E-shaped support structure, or T-shaped support structure.

A variation of the aspect above is, wherein the third support structure is embedded in each of the third edge of the first panel and the third edge of the second panel so the third support structure is not visible when the first panel is joined to the second panel.

A variation of the aspect above is, wherein the third support structure is an H-shaped support structure.

A variation of the aspect above is, wherein the outer covering includes a fabric material.

A variation of the aspect above is, wherein the plurality of panels further includes a third panel and a fourth panel, and the plurality of support structures further includes a fourth support structure, a fifth support structure, and a sixth support structure.

A variation of the aspect above is, wherein the fourth support structure is configured to join a first edge of the third panel and a first edge of the fourth panel, the fifth support structure is configured to join a second edge of the third panel and a second edge of the fourth panel, and the sixth support structure is configured to join a third edge of the third panel and a third edge of the fourth panel, the third edge of the third panel facing the third edge of the fourth panel when assembled. When assembled, the plurality of panels and the plurality of support structures can form a second subassembly.

A variation of the aspect above is, wherein the outer covering includes a first pocket and a second pocket separated by a hinge, the first pocket is configured to receive the first subassembly, the second pocket configured to receive the second subassembly. When assembled, the third edges of the panels can be arranged perpendicular to the hinge.

A variation of the aspect above is, wherein the first support structure is positioned along the hinge when the first subassembly is disposed within the first pocket of the outer covering, and wherein the fourth support structure is positioned along the hinge when the second subassembly is disposed within the second pocket of the outer covering.

A variation of the aspect above is, wherein the spa cover further includes a second vapor barrier configured to surround the second subassembly and disposed within the outer covering.

According to some embodiments, a spa cover configured to cover a spa shell includes a plurality of panels comprising a first panel and a second panel, a plurality of support structures joining the plurality of panels. The plurality of support structures including a first support structure, a second support structure and a third support structure. The spa cover can include an outer covering configured to cover the plurality of panels.

A variation of the aspect above is, wherein a first edge of the first panel and a first edge of the second panel are joined by the first support structure.

A variation of the aspect above is, wherein a second edge of the first panel and a second edge of the second panel are joined by the second support structure.

A variation of the aspect above is, wherein a third edge of the first panel and a third edge of the second panel are joined by the third support structure.

A variation of the aspect above is, wherein each of the first and second support structures include a C-shaped support structure, and wherein the third support structure includes an H-shaped support structure.

A variation of the aspect above is, wherein each of the first and second support structures include an E-shaped support structure, and wherein the third support structure includes an H-shaped support structure.

A variation of the aspect above is, wherein the first support structure includes a C-shaped support structure, the second support structure includes a T-shaped support structure, and the third support structure includes an H-shaped support structure.

A variation of the aspect above is, wherein the first support structure includes a E-shaped support structure, the second support structure includes a T-shaped support structure, and the third support structure includes an H-shaped support structure.

A variation of the aspect above is, wherein the first support structure, the second support structure, and the third support structure are at least partially embedded within the plurality of panels.

A variation of the aspect above is, wherein the plurality of panels further includes a third panel and fourth panel, and wherein the plurality of support structures further includes a fourth support structure, a fifth support structure, and a sixth support structure.

A variation of the aspect above is, wherein a first edge of the third panel and a first edge of the fourth panel are joined by the fourth support structure.

A variation of the aspect above is, wherein a second edge of the third panel and a second edge of the third panel are joined by the fifth support structure.

A variation of the aspect above is, wherein a third edge of the third panel and a third edge of the fourth panel are joined by the sixth support structure.

A variation of the aspect above is, wherein the fourth support structure, the fifth support structure, and the sixth support structure are at least partially embedded within the plurality of panels.

A variation of the aspect above is, wherein each of the plurality of panels is a foam panel.

A variation of the aspect above is, wherein the outer covering is removable.

A variation of the aspect above is, wherein the outer covering is a fabric covering.

According to some embodiments, a spa can include a spa shell including an interior space, a plurality of panels, each of the plurality of panels sized to be positioned within the interior space or footprint of the spa shell, a plurality of support structures configured to support the plurality of panels, each of the plurality of support structures sized to be positioned within the interior space or footprint of the spa shell.

A variation of the aspect above is, wherein the spa further includes an outer covering configured to cover the plurality of panels, the outer covering sized to be positioned at a footwell of the spa shell.

A variation of the aspect above is, wherein the plurality of panels are sized to be positioned above the outer covering and within the interior space or footprint of the spa shell.

A variation of the aspect above is, wherein the plurality of support structures are sized to be positioned above the plurality of panels and within the interior space or footprint of the spa shell.

A variation of the aspect above is, wherein the plurality of support structures are disposed in a single channel package, the single channel package extending from a first corner of the spa shell to a second corner of the spa shell. In other embodiments, the plurality of support structures may be split up into different packages all designed to be positioned within the interior space or footprint of the spa shell.

A variation of the aspect above is, wherein the spa further includes a first protective material positioned on the first corner of the spa shell and above a first end of the single channel package, and a second protective material positioned on the second corner of the spa shell and above a second end of the single channel package, the first and second protective materials configured to secure the single channel package.

A variation of the aspect above is, wherein each of the plurality of panels is a foam panel.

### BRIEF DESCRIPTION OF THE DRAWINGS

FIG. 1 shows a spa cover can including a plurality of panels attached to a spa unit.

FIG. 2 shows a partial enlarged view of the spa cover shown in FIG. 1.

FIGS. 3-5 show examples of packaging configurations for a spa unit including the spa cover shown in FIG. 1.

FIGS. 6A and 6B illustrate another example of a spa cover secured to a spa unit.

FIG. 6C shows an example of a fabric covering.

FIGS. 6D-6E show an example of a panel sealed inside a bag.

FIG. 7 shows a portion of the spa cover shown in FIGS. 6A and 6B.

FIG. 8 shows an exploded view of FIG. 7.

FIG. 9A shows an example of a C-shaped support structure attached to a plurality of panels.

FIG. 9B shows an example of an E-shaped support structure.

FIGS. 10A-10B show an example of a spa cover.

FIGS. 11A-11B show another example of a C-shaped support structure attached to a plurality of panels.

FIGS. 12A-12B show an example of an H-shaped support structure attached to a plurality of panels.

FIG. 12C shows another example of an H-shaped support structure.

FIG. 13A shows an example of a T-shaped support structure attached to a plurality of panels.

FIG. 13B shows another example of a T-shaped support structure.

FIG. 14A shows an example of a packaging configuration for a plurality of panels.

FIG. 14B shows an example of a packaging configuration for a plurality of support structures.

FIG. 14C shows a horizontal packaging configuration for a spa unit and spa unit components.

FIG. 14D shows a vertical packaging configuration for a spa unit and spa unit components.

FIG. 15 shows another example of a packaging configuration for a spa unit and spa unit components.

FIG. 16A shows another example of a horizontal packaging configuration for a spa unit and spa unit components.

FIG. 16B shows another example of a vertical packaging configuration for a spa unit and spa unit components.

FIG. 16C shows an example of a packaging configuration for a plurality of support structures.

### DETAILED DESCRIPTION

The present disclosure relates to a modular spa cover for covering an upper end of a spa shell or other water basin. The modular spa covers described herein are thinner and lighter than existing spa covers. This limits the amount of space occupied by the spa cover in inventory and during transport. Moreover, the modular spa cover can be used with different sized spa shells and reduce the number of different sized spa covers that need to be carried in inventory.

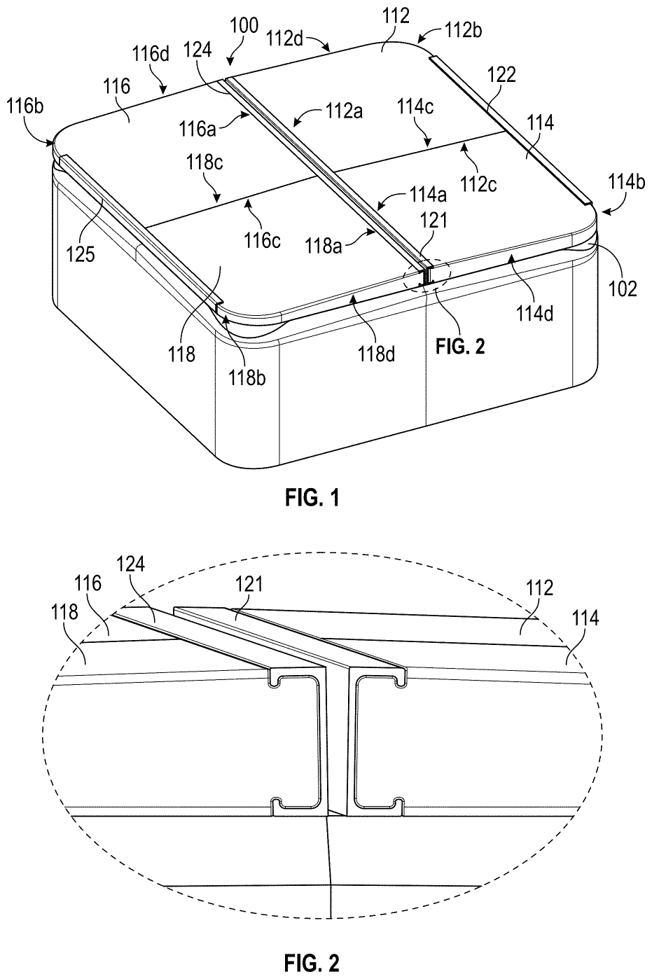

As shown in FIG. 1, the spa cover 100 can include a plurality of panels, for example two panels, three panels, four panels, or more. The spa cover 100 can at least partially cover a spa shell 102. In some cases, and as shown in FIG. 1, the spa cover 100 can include a first panel 112, a second panel 114, a third panel 116, and a fourth panel 118. Each panel 112-118 can include four edges. For example, the first panel 112 can include a first edge 112a, a second edge 112b, a third edge 112c, and a fourth edge 112d. The first and second edges 112a, 112b can be parallel to each other. The third and fourth edges 112c, 112d can also be parallel to each other. The second, third, and fourth panels 114, 116, 118 can similarly include four edges. For instance, the second panel 114 can include four edges 114a-114d, the third panel 116 can include four edges 116a-116d, and the fourth panel 118 can include four edges 118a-118d.

The plurality of panels can be foam panels including, but not limited to Neopor®, expanded polystyrene (EPS) foam, graphite polystyrene (GPS; graphite EPS) foam, expanded polypropylene (EPP) foam, Arcel® (EPS/EPE), or a combination thereof. The foam panels can make the spa cover thinner and lighter. Foam panels can also provide strength and insulation. At least some of the panels can be separated from other panels by a hinge, for example on the outer covering.

The spa cover 100 can include a modular frame. The modular frame can include plurality of support structures to stabilize the plurality of panels. For example, the spa cover 100 can include a first support structure 121, a second support structure 122, a third support structure (not shown), a fourth support structure 124, a fifth support structure 125, and a sixth support structure (not shown). The modular frame can include a same or different number of support structures compared to the number of panels. As illustrated, the spa cover can include four panels and six support structures, but different combinations are possible such as four panels and four support structures. Subsets of panels (e.g., two, three, or more panels) can be joined by one or more support structures, for example a subset of panels can be joined by one support structure at one edge of the subset of panels and another support structure at the opposite edge of the subset of panels. Any of the support structures disclosed herein can include one of a C-, I-, H-, E-, or T-shaped support structure. More details regarding the characteristics of the support structures are disclosed below.

In some cases, the first support structure 121 joins the first and second panels 112, 114 along the first edge 112a of the first panel 112 and the first edge 114a of the second panel 114, thereby forming a first continuous edge of the spa cover 100. The second support structure 122 can join the first and second panels 112, 114 along the second edge 112b of the first panel 112 and the second edge 114b of the second panel 114, thereby forming a second continuous edge of the spa cover 100. The third support structure can join the first and second panels 112, 114 along the third edge 112c of the first panel 112 and the third edge 114c of the second panel 114. The second edges 112b, 114b of the first and second panels 112, 114 can be an edge opposite the first edges 112a, 114a of the first and second panels 112, 114.

The fourth support structure 124 can join the third and fourth panels 116, 118 along the first edge 116a of the third panel 116 and the first edge 118a of the fourth panel 118, thereby forming a third continuous edge of the spa cover 100. The fifth support structure 125 can join the third and fourth panels 116, 118 along the second edge 116b of the third panel 116 and the second edge 118b of the fourth panel 118, thereby forming a fourth continuous edge of the spa cover 100. The sixth support structure can join the third and fourth panels 116, 118 along the third edge 116c of the third panel 116 and the third edge 118c of the fourth panel 118. The second edges 116b, 118b of the third and fourth panels 116, 118 can be an edge opposite the first edges 116a, 118a of the third and fourth panels 116, 118.

At least one of the support structures can be positioned adjacent an upper edge of the spa shell when attached to the spa shell 102. For example, the second and fifth support structures 122, 125 can be positioned adjacent an upper edge of the spa shell 102 when attached to the spa shell 102. The support structures may have different dimensions. For example, at least one support structure may have a length that is less than a length of the upper edge of the spa shell.

As shown in FIGS. 1 and 2, each of the support structures can include a channel to receive one or more of the plurality of panels. For example, the first and fourth support structures 121, 124 can include a channel that can receive one or more of the panels 112-118.

The spa cover 100 can include an outer covering to surround the plurality of panels. The outer covering may comprise a fabric material. The fabric material may be coated or lined with a moisture resistant material to prevent moisture from passing through the outer covering. The fabric covering may include one or more pockets enclosing one of more of the plurality of panels 112-118. For example, the fabric covering may have two pockets separated by a hinge. Each pocket can be designed to enclose one-half of the plurality of panels, for example two panels. In some cases, a first pocket can enclose the first and second panels 112, 114, and a second pocket can enclose the third and fourth panels 116, 118. The fabric covering can be removed and replaced.

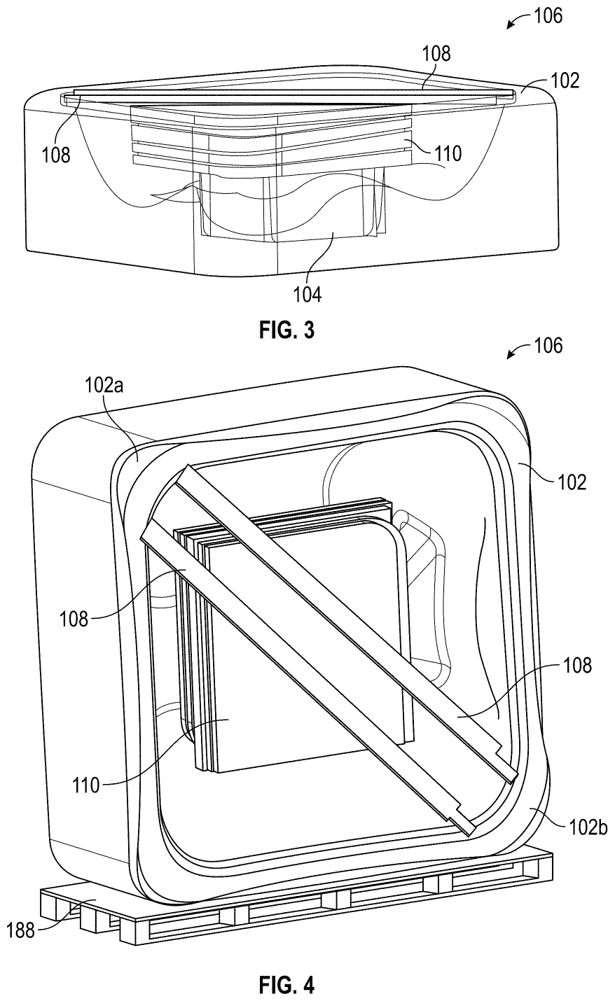

The plurality of panels 110 (e.g., panels 112-118) can be conveniently stacked and disposed inside the spa shell 102 to facilitate shipping of the same. For example, as shown in FIGS. 3 and 4, the spa cover 100 components can be packed within an interior space and/or footprint of the spa shell 102. A cardboard spacer 104 can be positioned at the footwell of the spa shell 102. The cardboard spacer 104 can beneficially provide support for the panels 112-118 when packed inside the spa shell 102. In some cases, the outer covering can be folded and positioned between the cardboard spacer 104 and at least one of the panels 112-118. The panels 112-118 can be positioned above the outer covering and within the interior space and/or footprint of the spa shell 102. The plurality of support structures can be positioned above the plurality of panels 112-118 and within the interior space and/or footprint of the spa shell 102, for example diagonally from a first corner 102a of the spa shell 102 to a second corner 102b of the spa shell. In some cases, the plurality of support structures can be packaged inside a box, such as boxes 108. All the spa cover components can be packaged in the spa shell at the end of production. In some cases, additional packaging materials including corrugated boxes, plastic wraps, and bubble wraps, can be used to package and protect the spas during transportation. The spa unit 106 and its components can be loaded into a pallet 188 for ease of transportation.

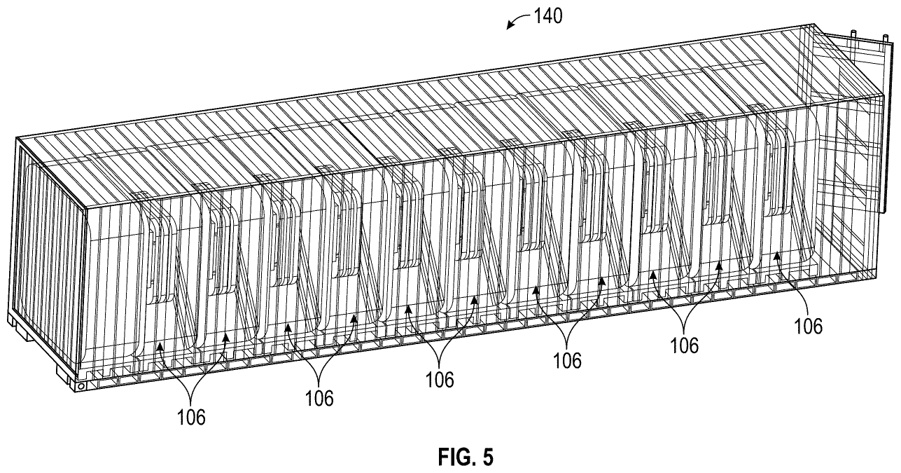

As shown in FIG. 5, a plurality of spa units 106 and their components can be packaged end-to-end inside a container 140 for transportation. During transportation, the spa covers, the plurality of support structures, and the panels 112-118 can be disposed entirely within the interior space of a spa shell 102. This can beneficially increase the number of spas that can be transported in a single container and reduce transportation costs and greenhouse gas emissions.

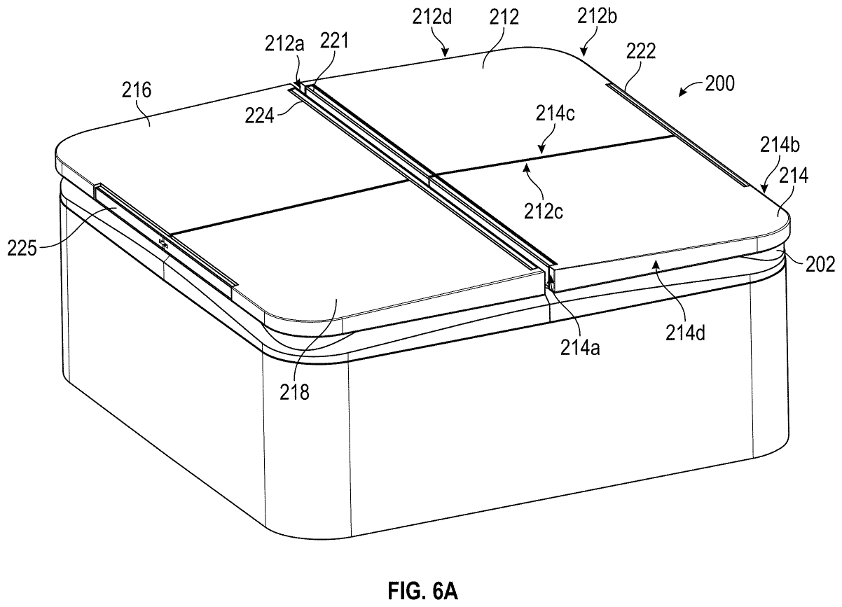

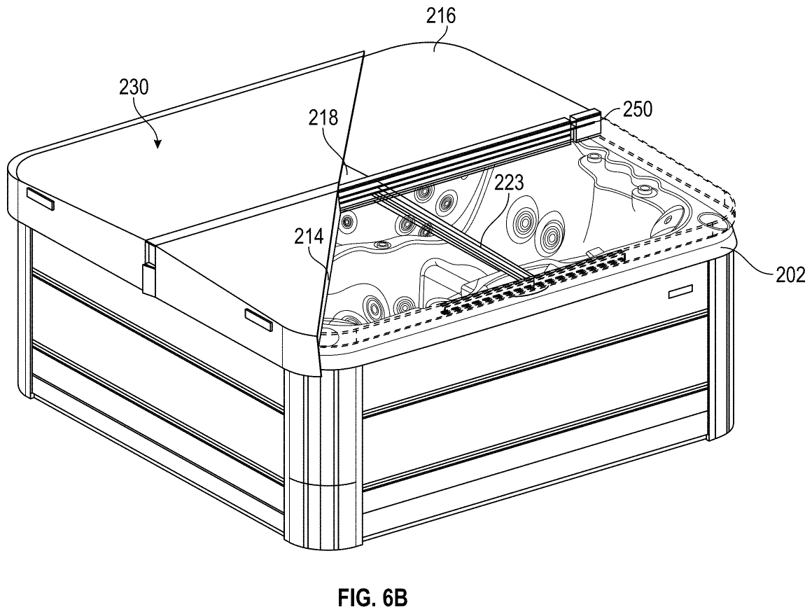

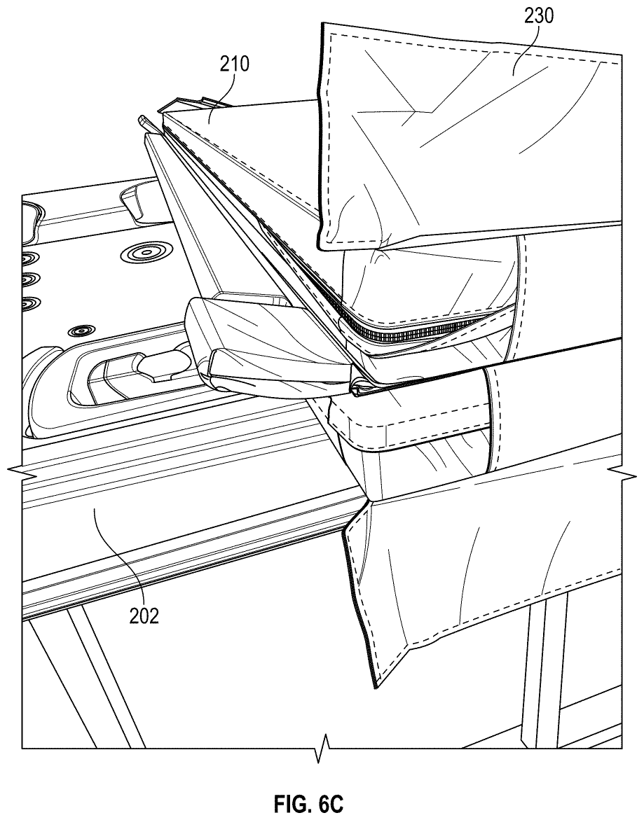

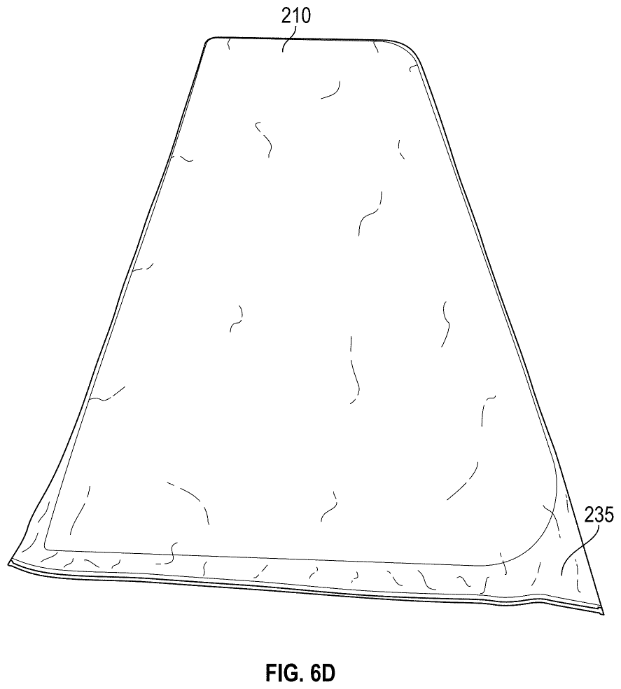

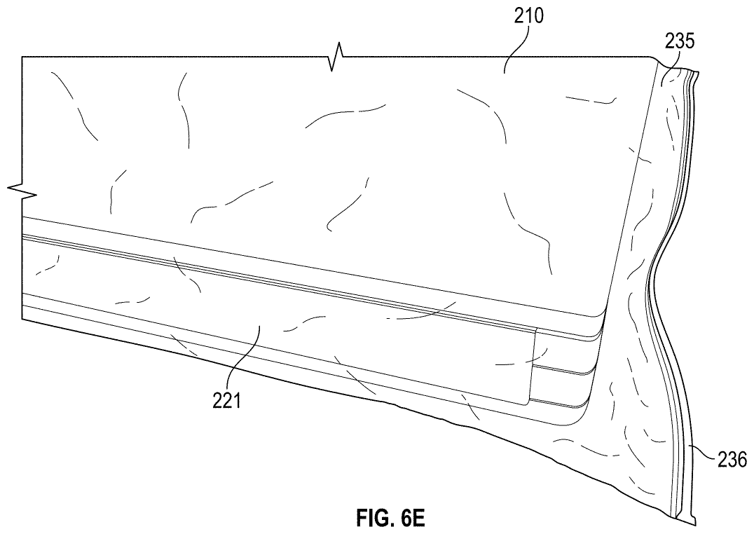

FIGS. 6A and 6B illustrate another spa cover 200 secured to a spa. The spa cover 200 can include any of the features described above with respect to the spa cover 100. The spa cover 200 can include a plurality of panels and be secured to a spa shell 202. The plurality of panels can include two or more panels. For example, the spa cover 200 can include a first panel 212, a second panel 214, a third panel 216, and a fourth panel 218. The panels 212-218 can be identical (e.g., all individual panels can have the same dimensions). The dimensions of each panel of the plurality of panels 212-218 can vary thus making the modular spa cover described herein compatible with different sized spa shells. As shown in FIGS. 6B-6C, a fabric covering 230, which can be identical or similar to the fabric covering described in relation to FIGS. 1-5, can enclose a plurality of panels 210, such as panels 212-218.

Each of the plurality of panels can include four edges. For example, the first panel 212 can include a first edge 212a, a second edge 212b, a third edge 212c, and a fourth edge 212d. The first and second edges 212a, 212b can be parallel to each other. The third and fourth edges 212c, 212d can also be parallel to each other. The second, third, and fourth panels 214, 216, 218 can similarly include four edges. For instance, the second panel 214 can include four edges 214a-214d.

The plurality of panels 212-218 can be foam panels, for example made of Neopor®. The panels 212-218 can be made of other materials including, but not limited to, expanded polystyrene (EPS) foam, graphite polystyrene (GPS; graphite EPS) foam, expanded polypropylene (EPP) foam, Arcel® (EPS/EPE), or a combination thereof. Beneficially, EPP foam provides insulation, is highly recyclable, has reduced water absorption, and is flexible. In some cases, the plurality of panels 212-218 can be made of extruded polystyrene (XPS). XPS can beneficially prevent the plurality of panels from absorbing fluids (e.g., water) which can result in foam degradation. The uniform and void-free structure of XPS can also beneficially result in stronger panels 212-218 and more efficient insulation. The use of foam for the plurality of panels 212-218 can beneficially result in a spa cover 200 that is thinner and lighter. The use of foam can also provide strength and insulation.

Each panel 212-218 can be tapered from an inner edge of the panel to an outer edge of the panel. For example, and without limitation, the inner edge of each panel can have a thickness (e.g., 4″) greater than a thickness (e.g., 2.5″) of the outer edge of the panel. This can beneficially prevent the accumulation of water or other liquids on a top surface of the spa cover 200 when the cover 200 is secured to the spa shell 202. To insulate the plurality of panels 212-218 from water, which can degrade the foam, the plurality of panels can be covered with a vapor barrier. For example, the plurality of panels 212-218 can be placed and sealed inside a bag 235 which can seal the plurality of panels 212-218 from the elements (e.g., water and chemicals therein), as shown in FIGS. 6D and 6E. In some cases, the bag 235 is made of polyethylene plastic film. The bag 235 can beneficially prevent the plurality of panels 212-218 from absorbing water which can cause the plurality of panels 212-218 to become heavy and lose their insulation value. The bag 235 can include, for example, a plastic bag which can be permanently sealed or resealable. For example, the bag can be sealed using a heat seal or a tool free mechanism such as a zipper mechanism 236.

The spa cover 200 can include a fabric covering 230 to surround the plurality of panels 212-218, as shown in FIG. 6B. The fabric covering 230 can be removed and replaced. Beneficially, the fabric covering 230 can improve sealing of the spa shell thereby preventing liquids and/or solids from accessing the interior of the spa shell 202 when the modular spa cover 200 is mounted to the spa. In some cases, the plurality of panels 212-218 can be disposed inside a bag (e.g., a plastic bag) which in turn can be disposed inside the fabric covering 230. The fabric covering 230 can also improve insulation by preventing the air inside the spa from escaping when the spa cover is mounted to the spa. In some cases, the fabric covering 230 can include a foil barrier. The foil barrier can be positioned on a water facing side of the fabric covering 230. The foil barrier can beneficially provide an additional layer of insulation which can help maintain the temperature inside the spa and the water therein when the modular spa cover 200 is mounted to the spa. In some cases, the plurality of panels 212-218 can be placed inside the bag 235 before being inserted into the fabric covering 230.

In some cases, the plurality of panels 212-218 and/or the fabric covering 230 can include a radiant barrier. The radiant barrier can reflect heat back into the spa and the water therein. This can beneficially reduce the energy required to heat the water. The radiant barrier can be sewn-in to a water facing side of the fabric covering 230, be slipped inside the fabric covering 230, or attached to the plurality of panels 212-218 (e.g., glued to a water facing side of the plurality of panels 212-218).

The spa cover 200 can include a modular frame. The modular spa cover 200 can include one or more support structures to stabilize the plurality of panels 212-218. For example, the plurality of support structures can include a first support structure 221, a second support structure 222, a third support structure 223, a fourth support structure 224, a fifth support structure 225, and a sixth support structure (not shown). Although reference is made to the modular spa cover 200 including six support structures, the modular spa cover 200 can include less than or more than six support structures. For example, the modular spa cover 200 can include one, two three, four, five, seven, eight, nine, etc., support structures. In some cases, the support structures 221-225 can be made of an extruded aluminum material. Beneficially, aluminum (e.g., from aluminum extrusion) is low weight, has high stiffness, and is chemically compatible with the foam material and other chemicals used in a spa environment such as ozone, chlorine, bromine, and Baqua. However, the support structures 221-225 can include other materials. For example, and without limitation, the support structures 221-225 can include nylon, PVC, or expanded PVC material, pultruded fiberglass (FRP—Fiber Reinforced Plastic), or a combination thereof.

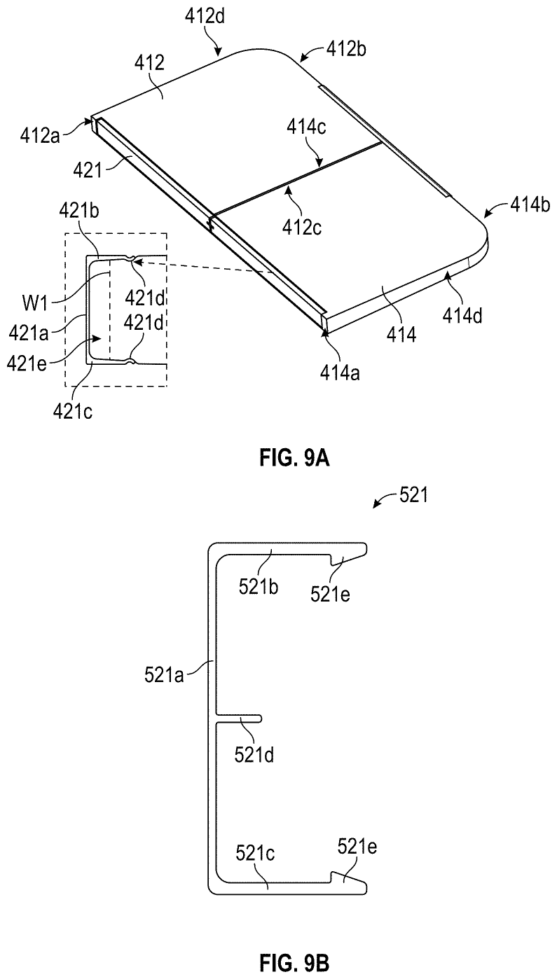

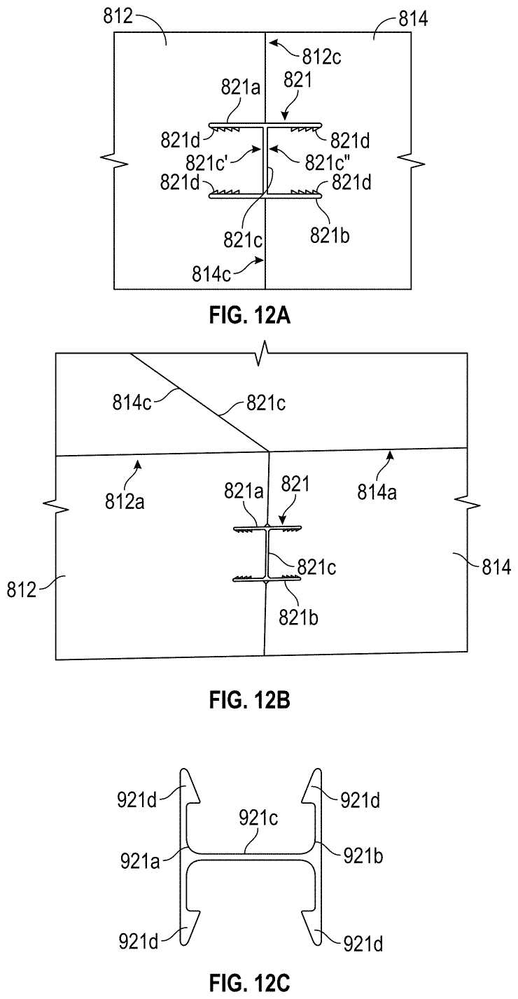

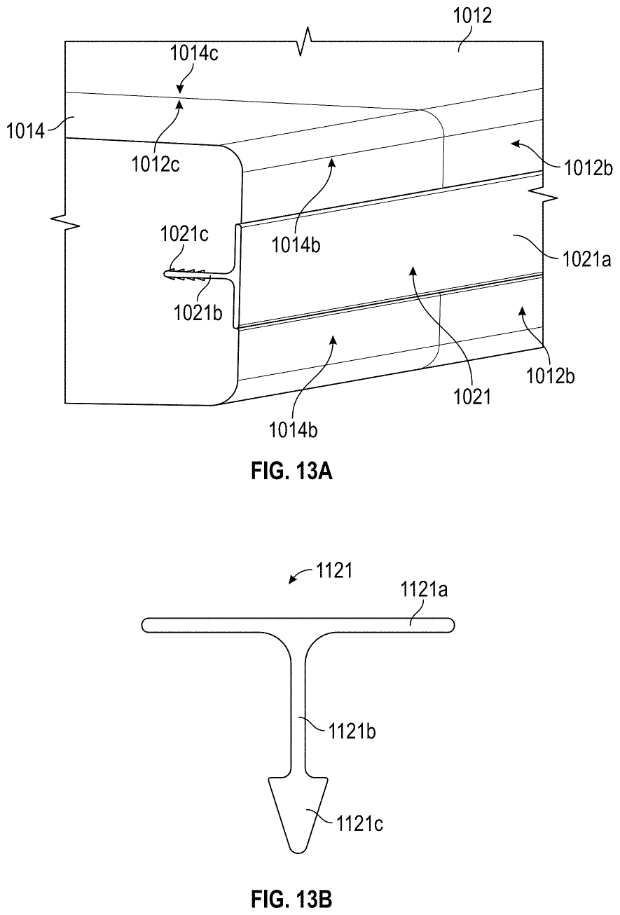

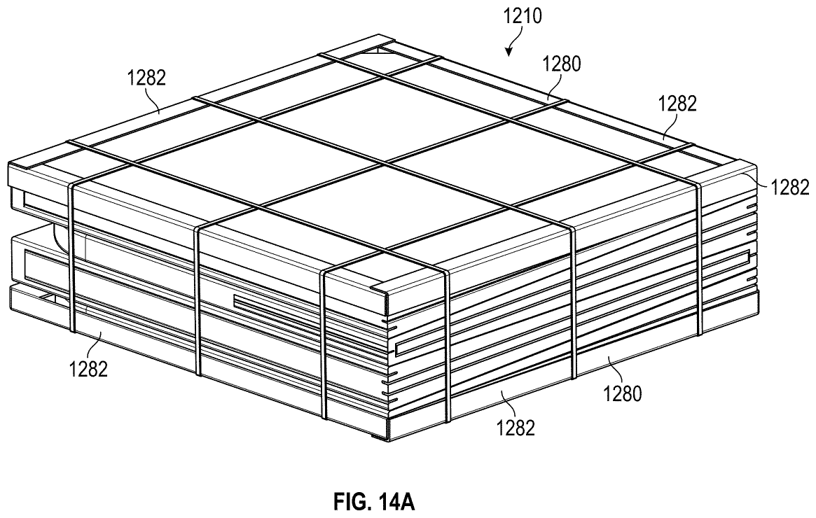

In some cases, the first support structure 221 can include an E-shaped support structure, such as the support structure 521 which is described in relation to FIG. 9B. The second support structure 222 can include a T-shape support structure, such as the support structures 1021 and 1121 which are described in relation to FIGS. 13A and 13B respectively. The third support structure 223 can include an H-shaped support structure, such as the support structures 821 and 921 which are described in relation to FIGS. 12A-12C. The first support structure 221 can join the first edge 212a of the first panel 212 with the first edge 214a of the second panel 214. When assembled, the first edges 212a, 214a of the first and second panels 212, 214 can form a continuous edge. The second support structure 222 can join the second edge 212b of the first panel 212 with the second edge 214b of the second panel 214. When assembled, the second edges 212b, 214b of the first and second panels 212, 214 can form a continuous edge. The third support structure 223 can join the third edge 212c with the third edge 214c of the second panel 214. When assembled, the third edges 212c, 214c of the first and second panels 212, 214 can face each other. The first and second panels 212, 214 can form a first subassembly.

The spa cover 200 can include a same or different number of support structures compared to the number of panels 212-218. Beneficially, the geometry, location, and material of the plurality of support structures 221-225 can increase the centered and distributed loading strength of the spa cover 200.

The spa cover 200 can include one or more hinges 250 separating the panels 221-225, but in other embodiments may have no hinges. The one or more hinges (e.g., one hinge, two hinges, or more) can separate one or more sections (e.g., two sections, three sections, or more) of the spa cover having one or more panels (e.g., two panels, three panels, four panels, or more). For example, a first half of the panels can be on one side of the hinge 250 and a second half of the panels can be on a second side of the hinge 250. As shown in FIG. 6B, the first panel 212 and the second panel 214 can be separated from the third panel 216 and the fourth panel 218 by the hinge 250. Adjacent panels on a first side of the hinge 250 can be joined by one or more support structures such as support structures 221-225.

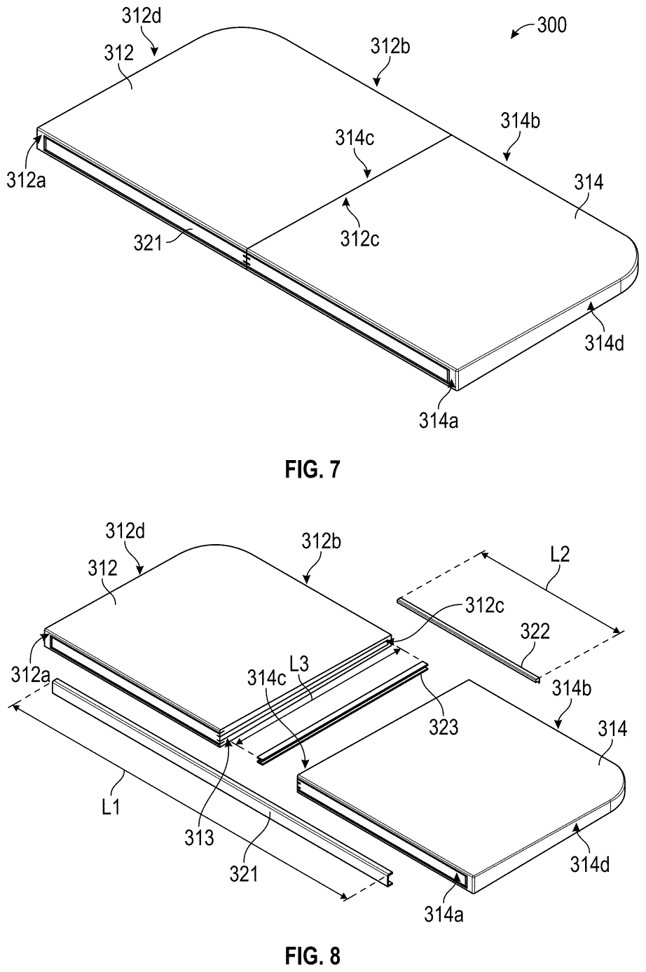

As shown in FIGS. 7 and 8, a modular spa cover 300 can include one or more support structures, which can be similar or identical to the support structures described in relation to FIGS. 1-6B, can stabilize at least two panels from a plurality of panels, which can be identical or similar to the plurality of panels 112-118, 212-218 described in relation to FIGS. 1-6B.

As shown in FIG. 8, the one or more support structures can include a first support structure 321, a second support structure 322, and third support structure 323 to stabilize two panels (e.g., a first panel 312 and a second panel 314). Each panel can include four edges. For example, the first panel 312 can include a first edge 312a, a second edge 312b, a third edge 312c, and a fourth edge 314d. The first edge 312a can be parallel to the second edge 312b, and the third edge 312c can be parallel to the fourth edge 312d. The first edge 312a can be perpendicular to the third and fourth edges 312c, 312d, and the third edge 312b can be perpendicular to the first and second edges 312a, 312b. The second panel 314 can include a first edge 314a, a second edge 314b, a third edge 314c, and a fourth edge 314d. The first edge 314a can be parallel to the second edge 314b, and the third edge 314c can be parallel to the fourth edge 314d. The first edge 314a can be perpendicular to the third and fourth edges 314c, 314d, and the third edge 314c can be perpendicular to the first and second edges 314a, 314b. In some cases, the panels may be supported by only one support structure, two support structures, or more.

The plurality of panels can include one or more grooves along their edges for receiving and securing the support structures 321-323. For example, the first panel 312 can include at least one groove 313 extending along the third edge 312c. The grooves 313 can extend the entire length of the third edge 312c. In some cases, the grooves 313 do not extend the entire length of the third edge 312c. The first edge 312a can include one or more grooves for receiving and securing the first support structure 321. The first edge 314a of the second panel 314 can also include a groove for receiving and securing the first support structure 321. The grooves along the first edges of the first and second panels 312, 314 can align when the first and second panels are attached to each other. The second panel 314 can also include grooves along the second edge 314b for receiving and securing the second support structure 322.

The support structures 321-323 can include at least one C-shaped support structure, at least one T-shaped structure, and/or at least one H-shaped support structure for each subset of adjacent panels (e.g., two, three, or more panels). As shown in FIG. 8, the first support structure 321 can include a C-shaped support structure, the second support structure 322 can include a T-shaped support structure, and/or the third support structure 323 can include an H-shaped support structure. For example, the first support structure 321 can join the first edges 312a, 314a of the first and second panels 312, 314. When assembled, the first edges 312a, 314a of the first and second panels 312, 314 are arranged lengthwise along the first support structure 321, as shown in FIG. 7. The second support structure 322 can join the second edges 312b, 314b of the first and second panels 312, 314. When assembled, the second edges 312b, 314b of the first and second panels 312, 314 are arranged lengthwise along the second support structure 322. The third support structure 323 can extend perpendicular to the first and second support structures 321, 322 and join the third edges 312c, 314c of the first and second panels 312, 314. When assembled, the third edges 312c, 314c of the first and second panels 312, 314 can face each other. In some cases, when attached to the first and second panels 312, 314, the third support structure 323 (e.g., the H-shaped support structure) can be embedded within the third edge 312c of the first panel 312 and the third edge 314c of the second panel 314 and thus not visible.

The support structures can include one or more support structures having different dimensions. For example, each of the plurality of support structures 321-323 can have a length equal to, larger than, or less than a length of the upper edge of the spa shell. The first, second, and third support structures 321-323 may have different lengths. For example, the first support structure 321 can have a length L1 larger than a length L2 of the second support structure 322 or a length L3 of the third support structure 323. The length L2 of the second support structure 322 can be shorter than the length L1 of the first support structure 321. In some cases, the first support structure 321 can be adjacent to a hinge, such as hinge 250 (which is described in relation to FIGS. 6A-6B). One or more of the edges of each panel can be substantially flat or completely flat. This can beneficially ensure a proper seal between panels when attached to each other thereby preventing liquids and/or solids from accessing the interior of the spa shell when the modular spa cover 300 is mounted to the spa.

In some cases, the support structures can include a channel configured to receive and support at least one of the plurality of panels. For example, and as shown in FIG. 9A, a C-shaped support structure 421 can include a channel 421e configured to receive and secure an edge of at least one of a plurality of panels 412, 414. The channel 421e can include a width W1 identical or substantially identical to a width W2 of an edge of the plurality of panels 412, 414. The support structures can include a snap-fit design. For example, and as shown in FIG. 9A, the support structure 421 can include one or more lobes 421d which partially snap and lock at least one of the plurality of panels 412, 414 in place.

Each of the plurality of panels can include four edges. For example, the first panel 412 can include a first edge 412a, a second edge 412b, a third edge 412c, and a fourth edge 412d. The first and second edges 412a, 412b can be parallel to each other. The third and fourth edges 412c, 412d can also be parallel to each other. The second panel 414 can include a first edge 414a, a second edge 414b, a third edge 414c, and a fourth edge 414d. The first and second edges 414a, 414b can be parallel to each other. The third and fourth edges 414c, 414d can also be parallel to each other.

A C-shaped support structure such as support structure 421 can include a first strut 421a, and second and third struts 421b, 421c extending from the first strut 421a. In some cases, the second and third struts 421b, 421c can extend substantially perpendicular to the first strut 421a. The second and third struts 421b, 421c can extend from opposite ends of the first strut 421a and along a length L2 of the support structure 421. In some cases, the lobes 421d can be positioned on the second and third struts 421b, 421c of the C-shaped structure 421. When attached to the panels 412, 414, the second and third struts 421b, 421c can be embedded within the panels 412, 414, and the first strut 421a can be flush with continuous edge formed by the first and second panels 412, 414. The support structure 421 can join the first edge 412a of the first panel 412 with the first edge 414a of the second panel 414. When assembled, the first edges 412a, 414a of the first and second panels 412, 414 can form a continuous edge.

The support structures may be at least partially flexible to facilitate installation of the panels to the support structures. Beneficially, the snap-fit design of the support structures can facilitate tool-free and convenient assembly of the modular spa cover. In some cases, an E-shaped support structure 521, as shown in FIG. 9B, can receive and lock at least one of the plurality of panels in place. The E-shaped support structure 521 can include a first strut 521a, and second, third, and fourth struts 521b, 521c, 521d extending from the first strut 521a. In some cases, the second, third, and fourth struts 521b-521d extend substantially perpendicular to the first strut 521a. The second and third struts 521b, 521c can extend from opposite ends of the first strut 521a and along a length of the support structure 521. The fourth strut 521d can extend substantially perpendicular to the first strut 521a and substantially parallel to the second and third struts 521b, 521c. In some cases, a length of the fourth strut 521d can be shorter than a length of the second and third struts 521b, 521c. The second and third struts 521b, 521c can have the same length or different lengths. In some cases, however, the second, third, and fourth struts 521a-521d all have the same length. The E-shaped support structure 521 can include a barbed design that can lock the E-shaped support structure to one or more of the plurality of panels. The E-shaped support structure 521 can include one or more barbs 521e positioned on any of the second, third, or fourth struts 521a-521d. For example, the support structure 521 can include two barbs positioned on the second and third struts 521b, 521c. The barbs 521e can beneficially snap and secure one or more panels to each other.

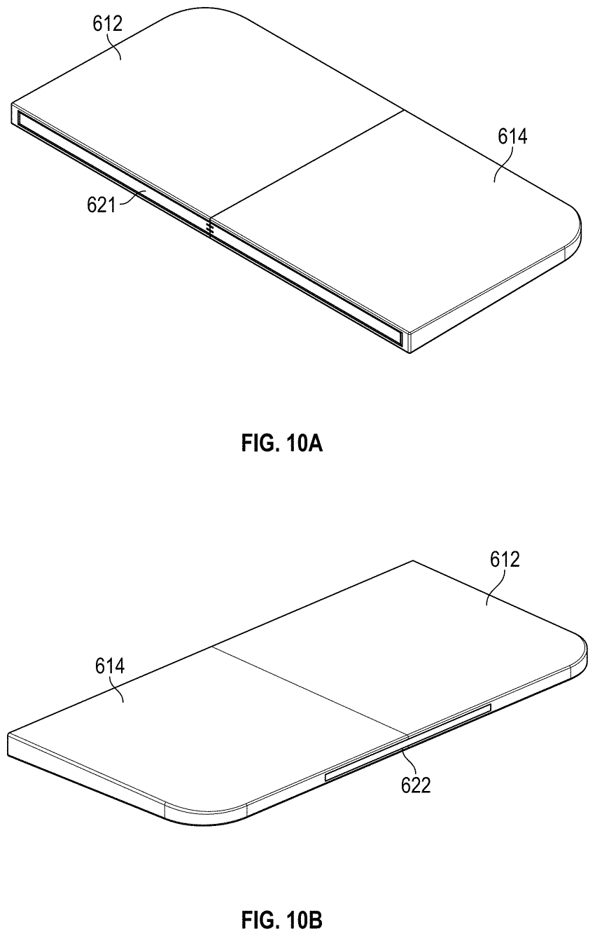

In some cases, the support structures are at least partially embedded within the plurality of panels, as shown in FIGS. 10A and 10B below. For example, a first support structure 621 and a second support structure 622 can be partially embedded within two panels 612, 614. When embedded in the panels 612, 614, one or more of the struts, such as struts 421b, 421c of the support structure 421 and struts 521d-521f of the support structure 521, of the support structure 621 can be at least partially embedded within the panels 612, 614.

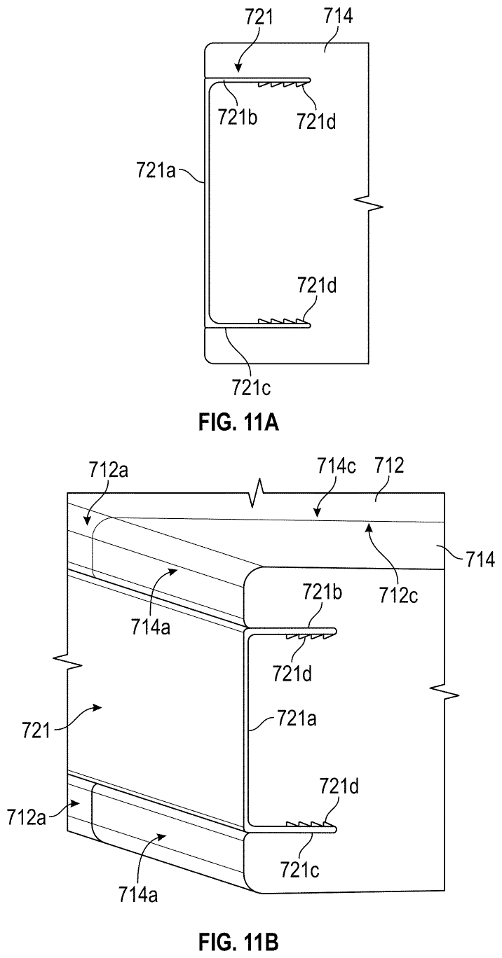

The plurality of support structures can include a barbed design, as shown in FIGS. 11A-13, which can lock the support structures to the plurality of panels. As shown in FIGS. 11A-13, at least a portion of each of the support structures can be embedded within the plurality of panels. As shown in FIGS. 11A and 11B, at least a portion of a C-shaped support structure 721 can be embedded within one or more panels 712, 714 to stabilize the plurality of panels 712, 714. The C-shaped support structure 721 can be embedded within the plurality of panels 712, 714 along an edge of each panel 712, 714.

Each of the plurality of panels 712, 714 can include four edges. For example, the first panel 712 can include a first edge 712a, a second edge (not shown), a third edge 712c, and a fourth edge (not shown). The first edge 712a and the second edge can be parallel to each other. The third edge 712c and the fourth edge can also be parallel to each other. The second panel 714 can include a first edge 714a, a second edge (not shown), a third edge 714c, and a fourth edge (not shown). The first edge 714a and the second edge can be parallel to each other. The third edge 714c and the fourth edge can also be parallel to each other. The support structure 721 can join the first edge 712a of the first panel 712 with the first edge 714a of the second panel 714. When assembled, the first edges 712a, 714a of the first and second panels 712, 714 can form a continuous edge.

The C-shaped support structure 721 can include a first strut 721a, and second and third struts 721b, 721c extending from the first strut 721a. In some cases, the second and third struts 721b, 721b extend substantially perpendicular to the first strut 721a. The second and third struts 721b, 721c can extend from opposite ends of the first strut 721a and along a length of the support structure 721. The second and third struts 721b, 721c can have the same length or different lengths. The C-shaped support structure 721 can include a barbed design that can lock the C-shaped support structure 721 to one or more of the plurality of panels 712, 714. The C-shaped support structure 721 can include one or more barbs 721d can be positioned on either or both of the second and third struts 721b, 721c. For example, the support structure 721 can include a plurality of barbs 721d positioned on one end of each of the second and third struts 721b, 721c. The plurality of barbs 721d can beneficially snap and secure one or more panels 712, 714 to each other. When attached to the plurality of panels 712, 714, each of the second and third struts 721b, 721c is embedded in at least one of the plurality of panels 712, 714 with the first strut 721a exposed to the environment. The first strut 721a of the support structure 721 can be flush with a continuous edge formed by the plurality of panels 712, 714 when the support structure 721 is attached to the plurality of panels 712, 714.

As shown in FIGS. 12A-12C, an H-shaped support structure can be embedded within two or more panels 812, 814 to stabilize the plurality of panels 812, 814. For example, an H-shaped support structure 821 can include first and second parallel struts 821a, 821b with a third strut 821c therebetween. The third strut 821c can extend perpendicular to the first and second parallel struts 821a, 821b. A length of the first and second parallel struts 821a, 821b can have a length at least as long as a length of the third strut 821c. In other embodiments, the support structure includes an I-shape where a length of the first and second parallel struts 821a, 821b have a length that is less than a length of the third strut 821c. The H-shaped support structure 821 can include a barbed design that can lock the H-shaped support structure 821 to one or more of the plurality of panels 812, 814. The H-shaped support structure 821 can include one or more barbs 821d positioned on either or both of the first and second struts 821a, 821b. For example, the support structure 821 can include a plurality of barbs 921d positioned on each end of the first and second struts 821a, 821b. The barbs 821d can beneficially snap and secure one or more panels 812, 814 to each other.

Each of the plurality of panels 812, 814 can include four edges. For example, the first panel 812 can include a first edge 812a, a second edge (not shown), a third edge 812c, and a fourth edge (not shown). The first edge 812a and the second edge can be parallel to each other. The third edge 812c and the fourth edge can also be parallel to each other. The second panel 814 can include a first edge 814a, a second edge (not shown), a third edge 814c, and a fourth edge (not shown). The first edge 814a and second edge can be parallel to each other. The third edge 814c and the fourth edge can also be parallel to each other. The support structure 821 can join the third edge 812c of the first panel 812 with the third edge 814c of the second panel 814. When assembled, the third edges 812c, 814c of the first and second panels 812, 814 can face each other.

In some cases, the support structure 821 can be at least partially embedded within the plurality of panels 812, 814. For example, the support structure 821 can be partially embedded within the plurality of panels 812, 814. When embedded in the panels 812, 814, the struts 821a, 821b can be at least partially embedded within the panels 812, 814. When attached to the plurality of panels 812, 814, each of the first and second struts 821a, 821b is embedded in at least one of the plurality of panels 812, 814 with third strut 821 disposed between two of the plurality of panels 812, 814. A first edge 821c′ of the third strut 821c can be flush with the third edge 812c of the first panel 812, and a second edge 821c″ of the third strut 821c can be flush with the third edge 814c of the second panel 814, when the support structure 821 is attached to the plurality of panels 812, 814.

FIG. 12C shows another example of an H-shaped support structure. The H-shaped support structure 921 can include first and second parallel struts 921a, 921b with a third strut 921c therebetween. The third strut 921c can extend perpendicular to the first and second parallel struts 921a, 921b. A length of the first and second parallel struts 921a, 921b can have a length at least as long as a length of the third strut 921c. The H-shaped support structure 921 can include a barbed design that can lock the H-shaped support structure 921 to one or more of the plurality of panels. The H-shaped support structure 921 can include one or more barbs 921d positioned on either or both of the first and second struts 921a, 921b. For example, the support structure 921 can include one barb 921d positioned on each end of the first and second struts 921a, 921b. The barbs 921d can beneficially snap and secure one or more panels to each other.

In some cases, the plurality of support structures can include a T-shaped support structure, as shown in FIGS. 13A and 13B. The T-shaped support structure can lock at least one of the plurality of panels in place and provide structural support. For example, a T-shaped support structure 1021 can include a first strut 1021a and a second strut 1021b. The second strut 1021b can extend perpendicular or substantially perpendicular to the first strut 1021a. A length of the first and second struts 1021a, 1021b can be the same or different. The T-shaped support structure 1021 can include a barbed design that can lock the T-shaped support structure 1021 to one or more of the plurality of panels 1012, 1014. The T-shaped support structure 1021 can include one or more barbs 1021c positioned on either or both of the first and second struts 1021a, 1021b. For example, the support structure 1021 can include a plurality of barbs 1021c positioned on one end of the second strut 1021b. The barbs 1021c can beneficially snap and secure one or more panels 1012, 1014 to each other. When attached to the plurality of panels 1012, 1014, the second strut 1021b is embedded in an edge of the plurality of panels 1012, 1014 with the first strut 1021a exposed to the environment. The first strut 1021a of the support structure 1021 can be flush with a continuous edge formed by the plurality of panels 1012, 1014 when the support structure 1021 is attached to the plurality of panels 1012, 1014.

Each of the plurality of panels 1012, 1014 can include four edges. For example, the first panel 1012 can include a first edge (not shown), a second edge 1012b, a third edge 1012c, and a fourth edge (not shown). The first edge and the second edge 1012b can be parallel to each other. The third edge 1012c and the fourth edge can also be parallel to each other. The second panel 1014 can include a first edge (not shown), a second edge 1014b, a third edge 1014c, and a fourth edge (not shown). The first edge and the second edge 1014b can be parallel to each other. The third edge 1014c and the fourth edge can also be parallel to each other. The support structure 1021 can join the second edge 1012b of the first panel 1012 with the second edge 1014b of the second panel 1014. When assembled, the second edges 1012b, 1014b of the first and second panels 1012, 1014 can form a continuous edge.

FIG. 13B shows another example of a T-shaped support structure. The T-shaped support structure 1121 can include a first strut 1121a and a second strut 1121b. The second strut 1121b can extend perpendicular or substantially perpendicular to the first strut 1121a. A length of the first and second struts 1121a, 1121b can be the same or different. The T-shaped support structure 1121 can include a barbed design that can lock the T-shaped support structure 1121 to one or more of the plurality of panels. The T-shaped support structure 1021 can include one or more barbs 1121c positioned on either or both of the first and second struts 1121a, 1121b. For example, the support structure 1121 can include a barb 1121c positioned on one end of the second strut 1121b. The barb 1121c can beneficially snap and secure one or more panels to each other.

The plurality of support structures can include a combination of one or more C-shaped, E-shaped, H-shaped, or T-shaped support structures. For example, and without limitation, the plurality of support structures can include at least one C-shaped support structure, at least one H-shaped support structure, and/or at least one T-shaped support structure. As another example, and without limitation, the plurality of support structures can include at least one E-shaped support structure, at least one H-shaped support structure, and/or at least T-shaped support structure. Beneficially, the embedded arrangement of the plurality of support structures within the plurality of panels can improve a thermal performance of the spa unit as the support structures will not be exposed to an interior space of the spa unit.

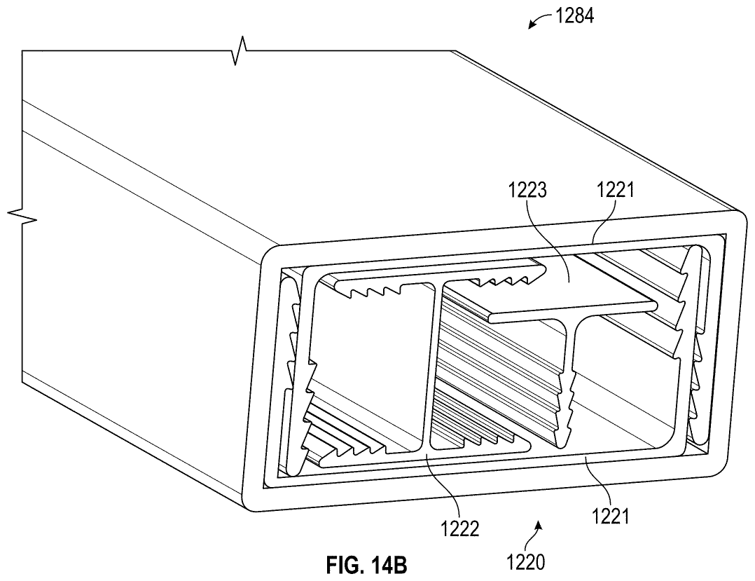

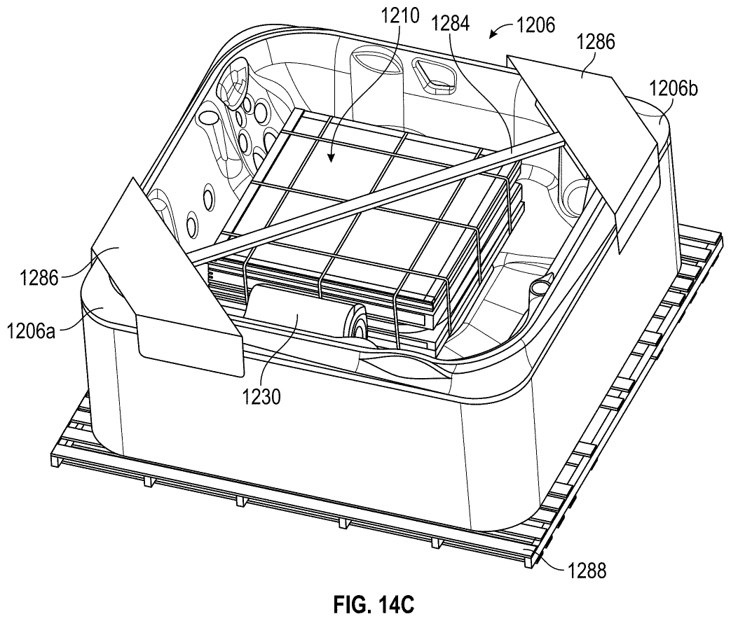

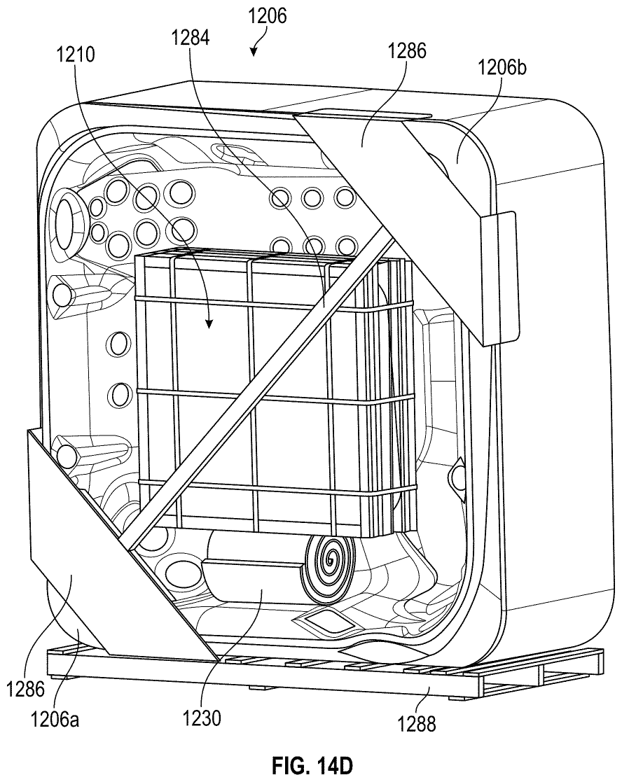

As shown in FIGS. 14C-14D, the components of the spa unit including, but not limited to the plurality of panels, the one or more support structures, and/or the fabric covering, can be packed within an interior space and/or footprint of the spa unit, such as the spa shell. Referring to FIG. 14A, the plurality of panels 1210 can be stacked and secured using straps 1280 and edge protectors 1282. The plurality of panels 1210 packaging can optionally or alternatively include a box and/or a bag. However, the plurality of panels 1210 can be stacked and positioned within an interior space of the spa unit 1206 without using a box and/or a bag. The plurality of support structures 1220 can be packed together as shown in FIG. 14B. For example, the packaging (e.g., box 1284) shown in FIG. 14B includes two C-shaped support structures 1221, one or more H-shaped support structures 1222, and one or more T-shaped support structures 1223, but any combination of the support structures described above may be packaged together. The H-shaped support structures 1222 and the T-shaped support structures 1223 can be disposed inside an area surrounded by the two C-shaped support structures 1221, as shown in FIG. 14B. The spa packaging can include more than one box 1284 to package and protect as many support structures 1220 as needed.

The plurality of panels 1210 can be packed within an interior space of the spa unit, as shown in FIG. 14C. For example, the plurality of support structures stored inside the one or more boxes 1284 can be positioned above the plurality of panels 1210 and within the spa unit 1206, as shown in FIGS. 14C-14D. Other components of the spa unit 1206 can also be packed within the interior space of the spa unit. Additional package protection can be added to protect the spa unit 1206 and its components, as shown in FIGS. 14C and 14D. For example, and without limitation, a couple of packing protectors 1286 can be positioned substantially along two opposing corners 1206a, 1206b of the spa unit 1206 for added protection during transportation, as shown in FIGS. 14C and 14D. In some cases, a packing protector 1286 can be positioned on each corner of the spa unit 1206. The corner protectors 1286 can also secure the package (the one or more boxes 1284) containing the plurality of support structures 1220 in place.

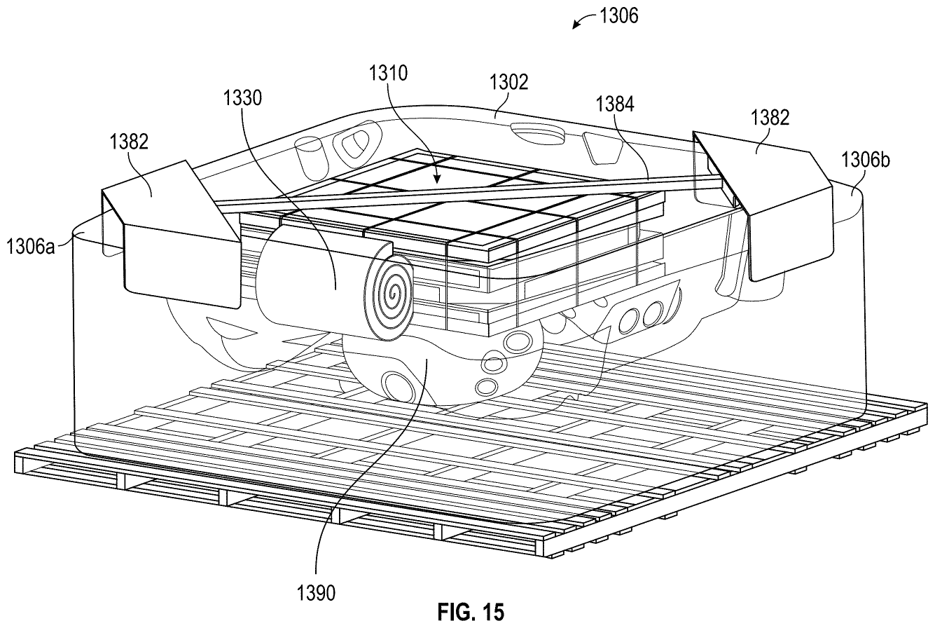

Additional packaging material can also be disposed between the packaging containing the plurality of panels 1210 and an interior wall of the spa unit 1206, as shown in FIGS. 14C and 14D. Beneficially, the additional packaging material can prevent the packaging containing the plurality of panels 1210 from being in direct contact with the interior walls of the spa unit 1206 thereby protecting the integrity of the spa unit's 1206 structure during transportation. In some cases, a fabric covering 1230, which can be similar or identical to the fabric covering 230 described in relation to FIGS. 6A-6B, can be rolled, as shown in FIGS. 14C-14D, and 15, and be positioned between the plurality of panels 1210 and an interior wall of the spa unit 1206. This arrangement can provide additional protection to the integrity of the spa unit during transport.

The spa unit 1206 can be packaged to be transported in a horizontal configuration, as shown in FIG. 14C, or in a vertical configuration, as shown in FIG. 14D. In a horizontal configuration, the spa unit 1206 rests on its bottom face. In a vertical configuration, the spa unit 1206 rests on one of its lateral faces. In either configuration (horizontal or vertical), the spa unit 1206 can be loaded into a pallet 1288 for ease of transportation.

As shown in FIG. 15, all the support structures may be packed together and positioned across a center of the spa shell from a first corner of the spa unit to a second corner of the spa unit. The support structure can be packed inside a box 1384 in an arrangement similar or identical to the arrangement described in FIGS. 14A-14D in relation to the box 1284. Ends of the box 1384 may be captured between packing supports 1382 including packing materials such as foam or hexicomb. In some cases, a packing support 1382 can be positioned on opposite corners 1306a, 1306b of the spa unit 1306. In this embodiment, the packing supports 1382 may extend outside of the footprint of the spa shell 1302 and/or above the spa shell 1302 to separate the spa shell 1302 from an adjacent spa shell. In some cases, a soft filler or packaging 1390 can be positioned beneath the plurality of panels 1310 on a bottom portion of the spa unit 1306, as shown in FIG. 15, to provide additional protection to the integrity of the spa unit 1306 during transport. The soft filler or packaging 1390 can be ball- or ring-shaped. The soft filler or packaging 1390 can be inflated or deflated. In some cases, a fabric covering 1330, which can be similar or identical to the fabric covering 230 described in relation to FIGS. 6A-6B and fabric covering 1230 described in relation to FIGS. 14C-14D, can be rolled and positioned between the plurality of panels 1310 and an interior wall of the spa unit 1306. This arrangement can provide additional protection to the integrity of the spa unit 1306 during transport.

In some embodiments, the plurality of support structures can be packed in separate packages. For example, at least one C-shaped support structure may be suspended above and across the plurality of panels from a first side of the spa shell to a second side of the spa shell, while other support structures can be suspended perpendicular thereto, for example along the top edge of the spa unit. When the support structures have different lengths, the longer C-shaped support structures may be suspended above and across the plurality of panels with the ends of the longer C-shaped support structures captured between shorter support structures extending perpendicular thereto. All the support structures may be positioned within the footprint of the spa shell.

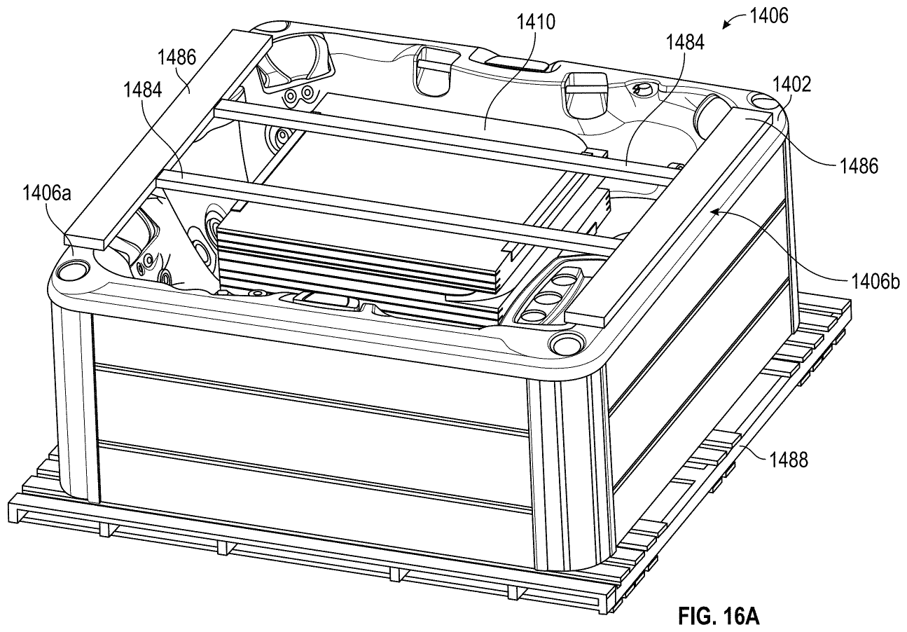

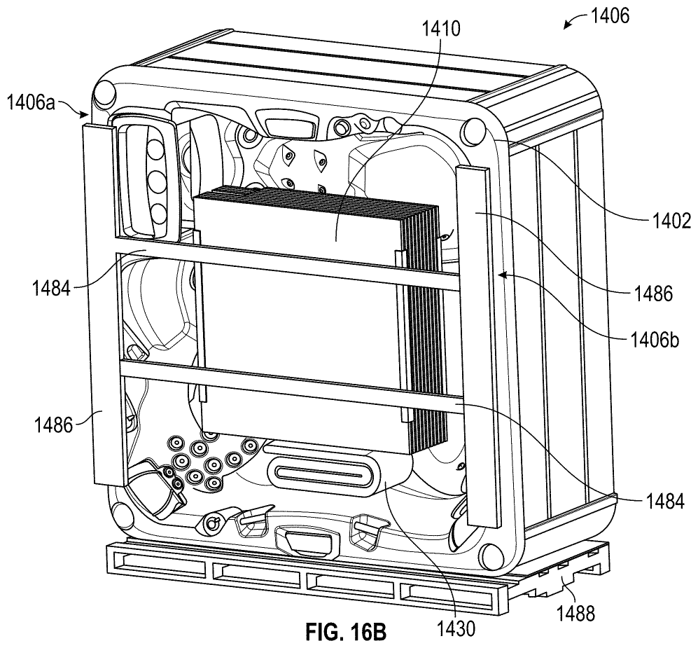

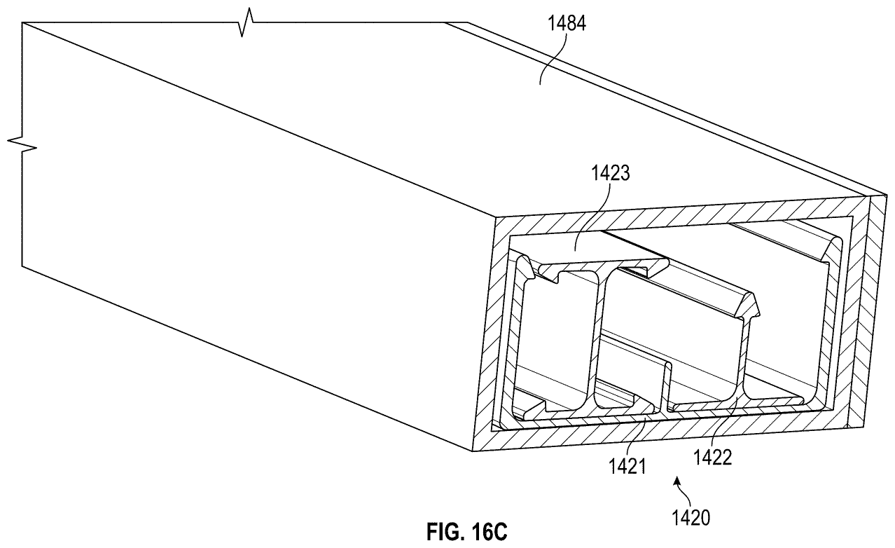

As shown in FIGS. 16A-16B, the components of the spa unit including, but not limited to the plurality of panels, the one or more support structures, and/or the fabric covering, can be packed within an interior space of the spa unit, such as the spa shell. The plurality of support structures 1420 can be packed together as shown in FIG. 16C. For example, the packaging (e.g., box 1484) shown in FIG. 16C includes at least one E-shaped support structure 1421, at least one T-shaped support structures 1422, and/or at least one H-shaped support structure 1423, but any combination of the support structures described above may be packaged together. The T-shaped support structure 1422 and the H-shaped support structure 1423 can be disposed inside an area surrounded by the E-shaped support structure 1421. The spa packaging can include more than one box 1484 to package and protect as many support structures 1420 as needed.

The plurality of panels 1410 can be packed within an interior space of the spa unit 1406, as shown in FIGS. 16A-16B. In some cases, the one or more boxes 1484 containing the plurality of support structures 1420 can be positioned above the plurality of panels 1410 and extend across the spa unit 1406, as shown in FIGS. 16A-16B. The one or more boxes 1484 can extend parallel or substantially parallel to each other. Opposite ends of the boxes 1484 can rest on opposite edges of the spa shell 1402. Other components of the spa unit 1406 can also be packed within the interior space of the spa unit 1406.

Additional package protection can be added to protect the spa unit 1406 and its components. For example, and without limitation, a couple of packing protectors 1486 can be positioned substantially along two opposing edges 1406a, 1406b of the spa unit 1406 for added protection during transportation. The packing protectors 1486 can secure the one or more boxes 1484 in place and prevent the one or more boxes 1484 from moving. In some cases, a fabric covering 1430, which can be similar or identical to the fabric covering 230 described in relation to FIGS. 6A-6B, can be rolled, as shown in FIGS. 16A-16B, and positioned between the plurality of panels 1410 and an interior wall of the spa unit 1406. This arrangement can provide additional protection to the integrity of the spa unit 1406 during transport.

The spa unit 1406 can be packaged to be transported in a horizontal configuration, as shown in FIG. 16A, or in a vertical configuration, as shown in FIG. 16B. In a horizontal configuration, the spa unit 1406 rests on its bottom face. In a vertical configuration, the spa unit 1406 rests on one of its lateral faces. In either configuration (horizontal or vertical), the spa unit 1406 can be loaded into a pallet 1488 for ease of transportation.

Although certain embodiments and examples are disclosed herein, inventive subject matter extends beyond the examples in the specifically disclosed embodiments to other alternative embodiments and/or uses, and to modifications and equivalents thereof. While we have described and illustrated in detail embodiments of a spa cover that includes a plurality of panels, it should be understood that our inventions can be modified in both arrangement and detail. Thus, the scope of the claims appended hereto is not limited by any of the particular embodiments described above. Additionally, the structures, systems, and/or devices described herein may be embodied as integrated components or as separate components. For purposes of comparing various embodiments, certain aspects and advantages of these embodiments are described. Not necessarily all such aspects or advantages are achieved by any particular embodiment. Thus, for example, various embodiments may be carried out in a manner that achieves or optimizes one advantage or group of advantages as taught herein without necessarily achieving other aspects or advantages as may also be taught or suggested herein.

Features, materials, characteristics, or groups described in conjunction with a particular aspect, embodiment, or example are to be understood to be applicable to any other aspect, embodiment or example described in this section or elsewhere in this specification unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The protection is not restricted to the details of any foregoing embodiments. The protection extends to any novel one, or any novel combination, of the features disclosed in this specification (including any accompanying claims, abstract and drawings), or to any novel one, or any novel combination, of the steps of any method or process so disclosed.

Furthermore, certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a claimed combination can, in some cases, be excised from the combination, and the combination may be claimed as a subcombination or variation of a subcombination.

The features and attributes of the specific embodiments disclosed above may be combined in different ways to form additional embodiments, all of which fall within the scope of the present disclosure. Also, the separation of various system components in the implementations described above should not be understood as requiring such separation in all implementations, and it should be understood that the described components and systems can generally be integrated together in a single product or packaged into multiple products.

For purposes of this disclosure, certain aspects, advantages, and novel features are described herein. Not necessarily all such advantages may be achieved in accordance with any particular embodiment. Thus, for example, those skilled in the art will recognize that the disclosure may be embodied or carried out in a manner that achieves one advantage or a group of advantages as taught herein without necessarily achieving other advantages as may be taught or suggested herein.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without other input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require the presence of at least one of X, at least one of Y, and at least one of Z.

Language of degree used herein, such as the terms “generally” and “substantially” as used herein represent a value, amount, or characteristic close to the stated value, amount, or characteristic that still performs a desired function or achieves a desired result. For example, the terms “generally” and “substantially” may refer to an amount that is within less than 10% of, within less than 5% of, within less than 1% of, within less than 0.1% of, and within less than 0.01% of the stated amount.

Although the spa cover has been disclosed in the context of certain embodiments and examples, it will be understood by those skilled in the art that the spa cover and subassemblies extend beyond the specifically disclosed embodiments to other alternative embodiments and/or uses of the embodiments and certain modifications and equivalents thereof. Accordingly, it is intended that the scope of the spa cover herein disclosed should not be limited by the particular disclosed embodiments described above but should be determined only by a fair reading of the claims that follow.

1. A spa cover configured to cover a spa shell, the spa cover comprising:
a plurality of panels comprising a first panel and a second panel;
a plurality of support structures comprising a first support structure, a second support structure, and a third support structure;
the first support structure is configured to join a first edge of the first panel and a first edge of the second panel;
the second support structure is configured to join a second edge of the first panel and a second edge of the second panel;
the third support structure is configured to join a third edge of the first panel and a third edge of the second panel, the third edge of the first panel facing the third edge of the second panel when assembled;
when assembled, the plurality of panels and the plurality of support structures form a first subassembly; and
an outer covering configured to cover the first subassembly.

2. The spa cover of claim 1, further comprising a first vapor barrier configured to surround the first subassembly and disposed within the outer covering.

3. (canceled)

4. (canceled)

5. (canceled)

6. The spa cover of claim 1, wherein when assembled:
the first support structure is embedded in the first edge of the first panel and the first edge of the second panel, at least a portion of the first support structure is exposed from the first panel and the second panel;
the second support structure is embedded in the second edge of the first panel and the second edge of the second panel, at least a portion of the second support structure is exposed from the first panel and the second panel;
the third support structure is embedded in each of the third edge of the first panel and the third edge of the second panel so the third support structure is not visible when the first panel is joined to the second panel.

7. The spa cover of claim 1, wherein the first support structure is an E-shaped support structure, the second support structure is a T-shaped support structure, and the third support structure is an H-shaped support structure.

8. (canceled)

9. (canceled)

10. (canceled)

11. (canceled)

12. (canceled)

13. The spa cover of claim 1, wherein:
the plurality of panels further comprises a third panel and a fourth panel; and
the plurality of support structures further comprises a fourth support structure, a fifth support structure, and a sixth support structure.

14. The spa cover of claim 13, wherein:
the fourth support structure is configured to join a first edge of the third panel and a first edge of the fourth panel;
the fifth support structure is configured to join a second edge of the third panel and a second edge of the fourth panel; and
the sixth support structure is configured to join a third edge of the third panel and a third edge of the fourth panel, the third edge of the third panel facing the third edge of the fourth panel when assembled;
when assembled, the plurality of panels and the plurality of support structures form a second subassembly.

15. The spa cover of claim 14, wherein the outer covering comprises a first pocket and a second pocket separated by a hinge, the first pocket configured to receive the first subassembly, the second pocket configured to receive the second subassembly.

16. The spa cover of claim 15, wherein the first support structure is positioned along the hinge when the first subassembly is disposed within the first pocket of the outer covering, and wherein the fourth support structure is positioned along the hinge when the second subassembly is disposed within the second pocket of the outer covering.

17. (canceled)

18. A spa cover configured to cover a spa shell, the spa cover comprising:
a plurality of panels comprising a first panel and a second panel;
a plurality of support structures joining the plurality of panels, the plurality of support structures comprising a first support structure, a second support structure and a third support structure; and
an outer covering configured to cover the plurality of panels.

19. The spa cover of claim 18, wherein a first edge of the first panel and a first edge of the second panel are joined by the first support structure, a second edge of the first panel and a second edge of the second panel are joined by the second support structure, and a third edge of the first panel and a third edge of the second panel are joined by the third support structure.

20. (canceled)

21. (canceled)

22. The spa cover of claim 18, wherein each of the first support structure comprises an E-shaped support structure, the second support structure comprises a T-shaped support structure, and the third support structure comprises an H-shaped support structure.

23. (canceled)

24. (canceled)

25. (canceled)

26. The spa cover of claim 18, wherein the first support structure, the second support structure, and the third support structure are at least partially embedded within the plurality of panels.

27. The spa cover of claim 19, wherein the plurality of panels further comprises a third panel and fourth panel, and wherein the plurality of support structures further comprises a fourth support structure, a fifth support structure, and a sixth support structure.

28. The spa cover of claim 27, wherein a first edge of the third panel and a first edge of the fourth panel are joined by the fourth support structure, a second edge of the third panel and a second edge of the third panel are joined by the fifth support structure, and a third edge of the third panel and a third edge of the fourth panel are joined by the sixth support structure.

29. (canceled)

30. (canceled)

31. (canceled)

32. The spa cover of claim 18, wherein each of the plurality of panels is a foam panel.

33. (canceled)

34. (canceled)

35. A spa comprising:
a spa shell comprising an interior space;
a plurality of panels, each of the plurality of panels sized to be positioned within the interior space of the spa shell;
a plurality of support structures configured to support the plurality of panels, each of the plurality of support structures sized to be positioned within the interior space of the spa shell.

36. The spa of claim 35, further comprising an outer covering configured to cover the plurality of panels, the outer covering sized to be positioned at a footwell of the spa shell, and wherein the plurality of panels are sized to be positioned above the outer covering and within the interior space of the spa shell.

37. (canceled)

38. The spa of claim 36, wherein the plurality of support structures are sized to be positioned above the plurality of panels and within the interior space of the spa shell.

39. The spa of claim 36, wherein the plurality of support structures are disposed in a single channel package, the single channel package extending from a first corner of the spa shell to a second corner of the spa shell.

40. The spa of claim 38, further comprising a first protective material positioned on the first corner of the spa shell and above a first end of the single channel package, and a second protective material positioned on the second corner of the spa shell and above a second end of the single channel package, the first and second protective materials configured to secure the single channel package.

41. (canceled)
